(19) United States
(12) Patent Application Publication
(10) Pub. No.: US 2009/0269451 A1
(43) Pub. Date: Oct. 29, 2009

(54) Fluorescent liquor and soda coloring composition and production method

(76) Inventor: David G. Perillo, Nyack, NY (US)

Correspondence Address: Jonathan D. Bick, Esq.;WolfBlock, 101 Eisenhower Parkway, Roseland, NJ, 07068, US

(21) Appl. No.: 12/150,032

(22) Filed: Apr. 24, 2008

(51) Int. Cl. A23L 2/58; C12G 3/04

(52) U.S. Cl. 426/250; 426/540

(57) ABSTRACT

A beverage typically a liquor or a carbonated soft drink composition including a fluorescent dye. The fluorescent beverage composition comprises a combination of one or more fluorescein dyes and an amount of material to neutralize said dye and combinations thereof. Effective use thereof as a colorant is possible by imparting thereto fluorescent properties to liquor and soda. The colorant may be added to various food products for use as a stable coloring matter.

### FIELD OF THE INVENTION

The present invention relates generally to the method of preparing glowing liquor and soda suitable for human consumption.

### BACKGROUND OF THE INVENTION

Luminescence is a phenomenon in which energy is specifically channeled to a molecule to produce an excited state. Return to a lower energy state is accompanied by release of a photon which is perceived as a glow. Luminescence includes fluorescence, phosphorescence, chemical luminescence and bioluminescence.

Nontoxic and environmentally neutral fluorescent dyes are used to color water. One of its more recognizable uses was in the Chicago River, where fluorescein was the first substance used to dye the river green on St. Patrick's Day in 1962. Fluorescein is also used as a water-soluble dye added to rainwater in environmental testing simulations to aid in locating and analyzing any water leaks, and in Australia and New Zealand as a methylated spirit dye to enable people to determine that certain alcohol is not fit to drink. In the health care field Fluorescein sodium is used extensively as a diagnostic tool in the field of ophthalmology, and increasingly during surgery for brain tumors.

While topical fluorescein is a useful tool topical, oral, and intravenous use of fluorescein can cause adverse reactions including nausea, vomiting, hives, acute hypotension, anaphylaxis and related anaphylactoid reaction, cardiac arrest, and sudden death. The most common adverse reaction is nausea, due to a difference in the pH from the body and the pH of the sodium fluorescein dye.

One short coming of the existing art of mixing dyes with liquids for the purpose of consumption is the difficulty of producing the product due to the need for precise formulation.

### SUMMARY OF THE INVENTION

A glowing beverage may be prepared. Reference to a beverage in this application generally means a beverage further defined as any of: liquor, spirits, liqueur, cordials, still or sparkling wine, still or sparkling water, carbonated drinks, energy drinks, nutraceutical and preventative drinks, juices and Jell-O (gelatin) shots. Liquor generally refers to alcoholic beverages. The liquor or soda should be clear. Mixed with the clear liquor or soda is an amount of mixture. The mixture is composed of at least one fluorescein dye and an amount of material to neutralize said dye. Said mixture be added directly to the liquor or soda or may be dissolved in an amount of alcohol for liquor or an amount of water for soda.

The preferred drink is clear. The dye should be safe for human consumption due either to the nature of the dye or the amount of the dye. The dying of cream or dairy beverages is possible but the glowing effect is minimal.

The preferred neutralizing material is common table salt. The amount of salt depends upon the dye used.

The glowing effect is activated by ultraviolet light, typically by “black-lights” employed in drinking establishments and entertainment venues. The effect is also produced by sunlight, natural or artificial, although the intensity, hue or fluorescence may differ.

The use of a buffer facilitates the existing difficulties of producing a product composed of dyes and liquids for the purpose of consumption which require a precise formulation.

### OBJECTS OF THE INVENTION

An object of the present invention is to improve the formulation of fluorescent drinks by adding a buffering agent.

Another object of the invention is to neutralize the adverse effects of the dye.

Still another object of the invention is to promote brand identification of beverages by color.

### DETAILED DESCRIPTION OF THE PREFERRED EMBODIMENT

The compositions of this invention are characterized as liquor or soda which emits light in a manner similar to, but much more vigorously if desired, than ordinary liquor or soda. These compositions have essentially the same visual appearance as a conventional carbonated beverage except that the glowing may be much more vigorous. These compositions differ from ordinary liquor or soda in that, typically, the glowing is much more visible than in an ordinary liquor or soda and have a neutral pH.

In the practice of this invention, the liquor or soda is selected to be clear. A clear liquor or soda allows the dye in the liquor or soda to be more visible. The exact clarity of the liquor or soda is not important, so long as it is clear enough to permit the dye to be seen.

The presence of the dye does not generally change the taste of the liquor or soda, since either; (a) the amount of dye is tiny or (b) the taste of the liquor or soda is strong.

Another unusual and unexpected characteristic of this invention relates to the slow and continued glowing given off by liquor or soda. Those skilled in the applications of the science of chemistry or physical chemistry are very familiar with the dissipating nature of glowing dyes. The combination of certain fluorescent dyes and pH buffer, such as common table salt in the present invention results in a markedly and unexpectedly extension of the time during which the dye will continuously glow from ½ hour to several hours without the need to reactivate the dye.

Preferred embodiments of the invention include common table salt as the ingestible substance capable of neutralizing said dye in a liquor or soda in an amount between 0.00025 g and 0.001 g per 1000 ml, with at least one fluorescent dye is in powdered form in an amount between 0.0025 g and 0.01 g per 1000 ml of liquor or soda, or in a liquid form in an amount between 0.0025 ml and 0.01 ml per 1000 ml of liquor or soda.

As contemplated herein, glowing liquor or soda of various character can be prepared. All such compositions will contain one or more recognized dyes and commonly available buffers such as table salt. One skilled in the art will recognize that variations and equivalences of the foregoing may be applied without departing from the spirit of the present invention.

What is claimed is:

1. A fluorescent beverage comprising: liquor or soda or water; at least one fluorescent dye; and an ingestible substance capable of neutralizing said dye in said liquor or said soda or said water.

2. The fluorescent beverage of claim 1, wherein the ingestible substance capable of neutralizing said dye in said liquor or said soda or said water is common table salt in an amount between 0.00025 g and 0.001 g per 1000 ml of said liquor or said soda or said water.

3. The fluorescent beverage of claim 1, wherein at least one fluorescent dye is in powdered form in an amount between 0.0025 g and 0.01 g per 1000 ml of liquor or soda.

4. The fluorescent beverage of claim 1, wherein at least one fluorescent dye is in liquid form in an amount between 0.0025 ml and 0.01 ml per 1000 ml of liquor or soda.

5. A method of formulating a beverage comprising the steps of: introducing a quantity of a liquor or a soda or water to a container, adding a fluorescent dye, adding an ingestible substance capable of neutralizing aid dye in said liquor or said soda or said water.
